(19) United States
(12) Patent Application Publication
(10) Pub. No.: US 2015/0105057 A1
(43) Pub. Date: Apr. 16, 2015

(54) Simplified Cell Phone

(71) Applicant: Keith Schaffner, Dunedin, FL (US)

(72) Inventor: Keith Schaffner, Dunedin, FL (US)

(21) Appl. No.: 14/263,472

(22) Filed: Apr. 28, 2014

Related U.S. Application Data
(60) Provisional application No. 61/890,417, filed on Oct. 14, 2013.

(51) Int. Cl. H04M 3/02; H04M 3/42; H04M 1/66; H04W 4/16; H04M 1/02

(52) U.S. Cl. CPC H04M 3/02; H04W 4/16; H04M 1/0245; H04M 1/66; H04M 3/42042
USPC 455/418

(57) ABSTRACT

A simplified cell phone is provided. The present simplified cell phone is able to call only a single pre-programmed phone number and automatically calls that number when the phone is opened, without any additional actuation by the user. The device has a simplified design, allowing the device to be utilized by users who lack the technological acumen to properly make use of modern mobile phones, such as elderly individuals or extremely young children.

### CROSS REFERENCE TO RELATED APPLICATION

This application claims the benefit of U.S. Provisional Application No. 61/890,417 filed on Oct. 14, 2013. The above identified patent application is herein incorporated by reference in its entirety to provide continuity of disclosure.

### BACKGROUND OF THE INVENTION

1. Field of the Invention

The present invention relates to cellular telephones. More specifically, the present invention relates to cellular telephones adapted for elderly individuals, extremely young children, or emergency situations.

As mobile technology has grown more powerful and more ubiquitous, mobile devices have grown increasingly complicated because users rely on them to perform an increasingly large variety of tasks. However, as mobile electronic devices have become more powerful and able to perform a greater number of tasks, their complexity has also risen at a proportional level. Many individuals lack the technological acumen to perform even relatively simple tasks using smartphones, including making calls, because even these simple actions generally require multiple button presses or sorting through menus, assuming that the individual would have an idea of where to look for these buttons or menus. This inability to use modern phones can be particularly dangerous in emergency situations where an individual absolutely needs to be able to contact someone and faces substantial consequences for being unable to do so. Therefore, there is a need in the prior art for a cell phone that can be used by individuals with Alzheimer's, very young children, or other such individuals that lack the technological acumen to use cell phones.

Various prior art mobile phones are available that are intended to be used by individuals that lack the capability to use complicated modern smartphones, whether in emergency situations or not. These phones feature extra-large buttons or text so that elderly users with poor eyesight can better make out the inputs, paired down menus or keyboards, or restricted calling authority. What is common to all of these prior art devices, however, is that they still require a user to input commands to the phone to accomplish even the basic task of initiating a telephone call. Even this type of task may be too challenging for an individual afflicted with Alzheimer's disease or an extremely young child due to their lack of familiarity with the technology or inability to make quick decisions in an emergency situation. Therefore, there is a need in the prior art for a mobile phone that requires zero input from the user whatsoever to make a phone call.

The present invention comprises a mobile phone that automatically calls a pre-programmed number once it is opened, without requiring any additional actuation on the part of the user. In order to make a phone call, the user need not read any menus, press any buttons, or make any decision other than opening the phone. The present design is ideally suited for individuals to whom even other types of simplified mobile phones are too complex to operate, such as individuals with Alzheimer's or extremely young children. The number that the present simplified mobile phone automatically calls when opened can be programmed by an individual through a user interface by connecting the present invention to another electronic device, such as a laptop. The present invention stores that number and then accesses and automatically calls that number when the phone is opened, giving individuals who lack the capability to use a mobile phone the ability to make a phone call.

2. Description of the Prior Art

Devices have been disclosed in the prior art that relate to simplified cell phones. These include devices that have been patented and published in patent application publications. These devices generally relate to devices having a limited number of buttons or a set of pre-programmed telephone numbers. The following is a list of devices deemed most relevant to the present disclosure, which are herein described for the purposes of highlighting and differentiating the unique aspects of the present invention, and further highlighting the drawbacks existing in the prior art.

Many mobile electronic devices that are designed for children or elderly individuals are known in the prior art. These patents include U.S. Pat. No. 8,086,283 to Parker et al., U.S. Pat. No. 7,460,883 to McBrearty et al., U.S. Pat. No. 6,912,399 Zirul et al., U.S. Pat. No. 6,785,387 Albrecht et al., and U.S. Pat. No. 5,365,570 to Boubelik. Many of these devices restrict the number of other phones that the user may call or the number of other phone from which the user may receive calls and also feature simplified keypads. These devices are either simplified so that they can be easily used by individuals unfamiliar with modern smartphones in emergency situations or have restricted dialing authority to prevent unwanted contact with strangers. All of these devices fail to teach a device as in the present invention wherein the phone makes a call to a pre-programmed number as soon as it is flipped open, with no other actuation required by the user. All of the cited devices require users to push additional buttons or make selections from menus in order to connect a phone call. These requirements make the devices too complicated for some individuals to use reliably, potentially endangering them in emergency situations or making their daily lives unnecessarily frustrating.

The present simplified cell phone provides a mobile electronic device that is capable of making calls to a pre-programmed phone number without any actuation from the user, except for merely opening the phone. The present invention is designed for use by very young children, individual's with Alzheimer's, and other such individuals that do not have the ability to use modern smartphones due to their complexity. The present invention eliminates all buttons, except for a power button and a volume button, completely obviating the need for the user to make any button presses to make a call. It substantially diverges in design elements from the prior art and consequently it is clear that there is a need in the art for an improvement to existing simplified mobile electronic devices adapted for use by children or elderly persons. In this regard the instant invention substantially fulfills these needs.

### SUMMARY OF THE INVENTION

In view of the foregoing disadvantages inherent in the known types of simplified mobile electronic devices now present in the prior art, the present invention provides a new simplified cell phone wherein the same can be utilized for providing convenience to users who are unable to user modern smartphones due to their complexity.

It is therefore an object of the present invention to provide a new and improved simplified cell phone device that has all of the advantages of the prior art and none of the disadvantages.

It is another object of the present invention to provide a simplified cell phone device that is able to make calls without a single button press by the user.

Another object of the present invention is to provide a simplified cell phone device that is only capable of calling a single number and wherein that number is programmable or otherwise alterable.

Another object of the present invention is to provide a simplified cell phone that can be used by individuals with Alzheimer's, extremely elderly individuals, extremely young individuals, or other types of users that lack the general technological acumen to operate a modern smartphone.

Another object of the present invention is to provide a simplified cell phone that is adapted to quickly make phone calls to a pre-determined telephone number in emergency situations.

Yet another object of the present invention is to provide a simplified cell phone that is adapted to be connected to another electronic device so that it can be reprogrammed.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the present invention in its open configuration.

FIG. 1B shows a perspective view of the present invention in its closed configuration.

FIG. 2A shows a diagram of the outgoing call system of the present invention.

FIG. 2B shows a diagram of the incoming call system of the present invention.

FIG. 2C shows a diagram of the input system of the present invention.

### DETAILED DESCRIPTION OF THE INVENTION

Reference is made herein to the attached drawings. Like reference numerals are used throughout the drawings to depict like or similar elements of the simplified cell phone. For the purposes of presenting a brief and clear description of the present invention, the preferred embodiment will be discussed as used by individuals who lack the technological acumen to use modern cell phones. The figures are intended for representative purposes only and should not be considered to be limiting in any respect.

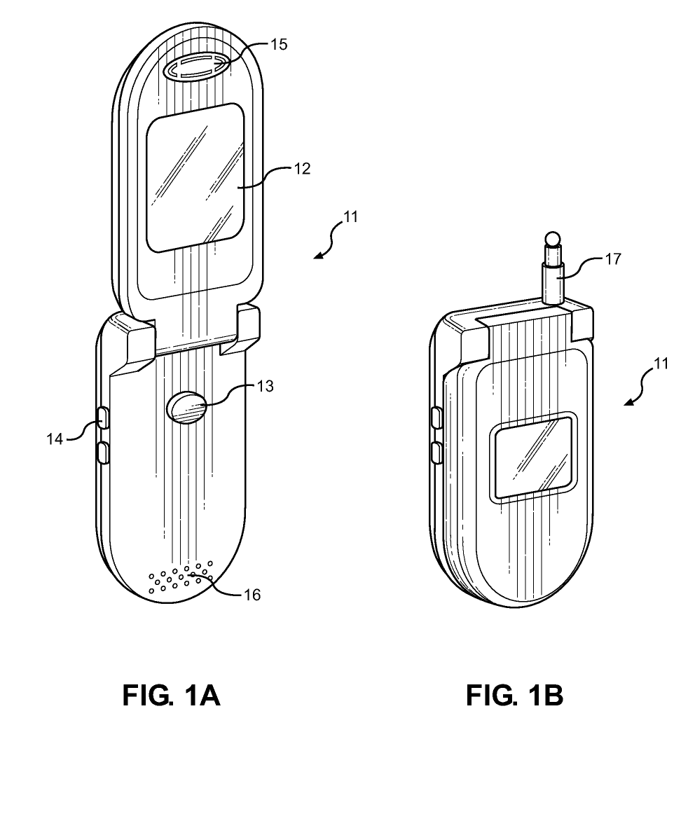

Referring now to FIGS. 1A and 1B, there are shown perspective views of the present invention in its various configurations. The present invention comprises a flip phone 11 having a screen 12, a power button 13, at least one volume button 14, a speaker 15, a microphone 16, and an antenna 17. The flip phone 11 housing comprises a first and a second member hingedly attached to each other, wherein the various components are disposed across the members. No claim is made as to the specific shape, size, or design of the flip phone 11 housing or the arrangement of the buttons 13, 14. The present invention further comprises a storage medium, a battery, and a circuit board containing a microprocessor, a digital signal processor, a wireless transceiver, and other electrical elements essential to the operation of any cell phone's ability to send and receive phone calls over a cellular network. The present invention is designed to be an extremely stripped-down version of a cell phone that lacks all non-essential characteristics, thereby being as simple as possible for individuals to use. The screen 12 is adapted to display information relevant to the individual using the present invention, such as the phone number and identity of the individual to which the stored number corresponds and the length of the currently-connected call. In an alternative embodiment of the present invention, the screen 12 is adapted to display a picture or image of the individual to which the incoming or outgoing phone number belongs to assist individuals who suffer from Alzheimer's in knowing to whom they are speaking. The antenna 17, speaker 15, microphone 16, wireless transceiver, digital signal processor, and other essential elements of a cell phone function just as they do in a conventional cell phone. It is submitted that the methods of connecting cell phone users together using a network of cell phone towers, transmitting and receiving signals over said cellular network, processing said signals, and performing the other functions inherent to all cell phone use are known in the art.

The present invention is designed so that it automatically calls a pre-programmed phone number once the phone is opened, as depicted in FIG. 1A, from its closed position, as depicted in FIG. 1B. When the user closes the phone 11, the connected call automatically ends. The present invention lacks a keyboard or any other means capable of transmitting user input, except for a power button 13 or volume buttons 14. The only actuation to which the present invention's systems respond, except when connected to another electronic device, is the phone 11 being opened, the power button 13 being pressed, or the volume buttons 14 being pressed. The phone 11 is adapted to detect when it is opened in a number of different ways, including having the actuation of the hinge be detected by the electrical circuitry components of the present invention, which thereby triggers the phone call, or by having at least one accelerometer disposed within the headset portion of the phone 11 that detects when the phone is opened, which thereby triggers the phone call. However, no claim is made as to the precise means by which the present invention detects when it is opened and thereafter initiates a phone call to the pre-programmed phone number. The opening of the phone 11 is the sole actuation by which a phone call to the pre-determined number may be triggered and said actuation automatically triggers said phone call.

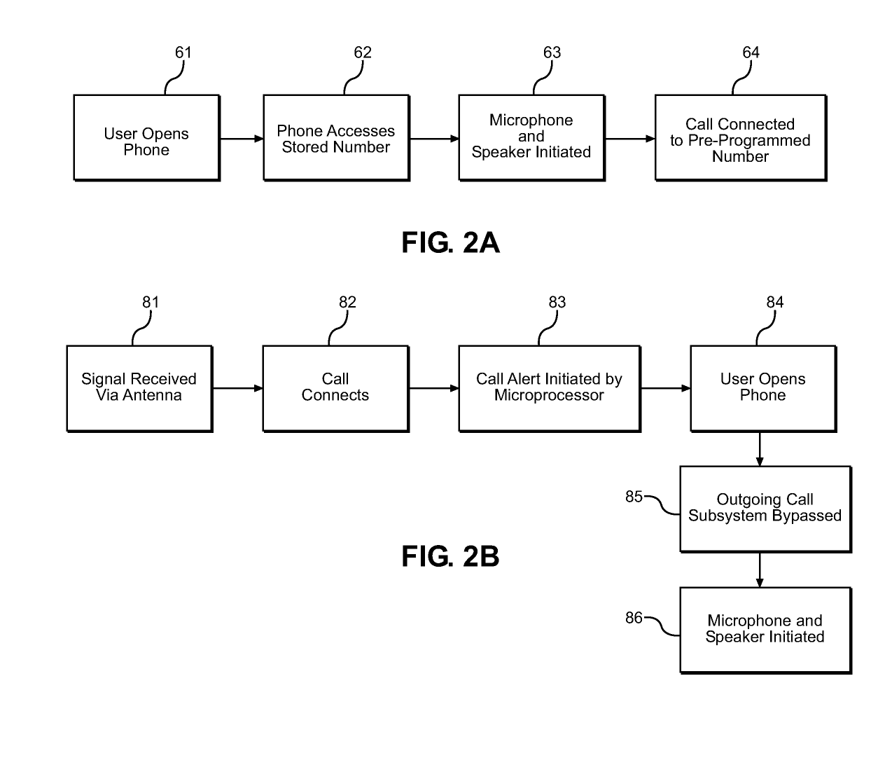

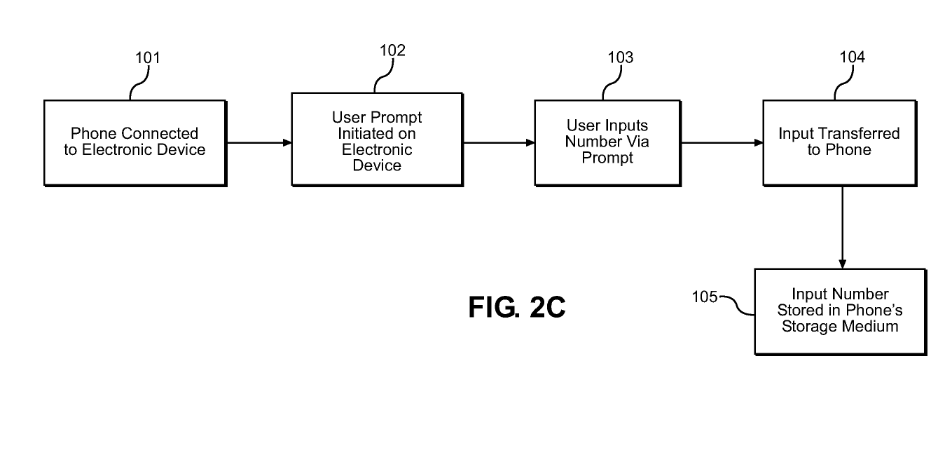

Referring now to FIG. 2A, there is shown a diagram of the outgoing call system of the present invention. The present simplified mobile phone comprises three separate subsystems that control its various processes: the outgoing call system, the incoming call system, and the input system. The outgoing call system operates in four distinct steps. First, the present invention detects when the user opens the phone 61. The present invention then accesses 62 the single phone number stored within its storage medium. The present invention then initiates 63 the microphone and speaker disposed on the phone's housing. Just as with a conventional mobile phone, the microphone and speaker allow the user to communicate with the individual to which the user is connected by converting recorded sound into a signal to be transmitted over the cellular network or converting the signal received over the cellular network into sound. Lastly, the outgoing call system of the present invention calls and connects 64 to the pre-programmed phone number. As described above, no specific claim is made as to the method by which the outgoing call system detects when the phone is opened. The storage medium may comprise any type of data storage commonly known in the prior art of mobile phones, including internal memory, a memory card, or cloud-based wireless storage. Furthermore, the present simplified mobile phone connects cell phone users together via a cellular network in precisely the same manner as conventional cell phones connect users together, i.e. the cell phone remains in contact with a cell tower at all times and switches cell phone towers as the user moves in and out of the cells of the cellular network, the cell phone has a wireless transceiver for sending and receiving digital signals over said cellular network, and the cellular network connects users to each other by determining and modulating the frequency of the remote cell phones through which they are to be connected.

Referring now to FIG. 2B, there is shown a diagram of the incoming call system of the present invention. The incoming call system is initiated when a signal is received 81 over the cellular network to which the present invention is connected. Once the signal is received 81 from the cellular network, the call connects 82 and the microprocessor of the present invention initiates a call alert 83, which may comprise a vibration or an audible tone. If the user then chooses to open 84 the present phone in response, the microphone and speaker are initiated 86 and the user and the remote individual are then free to speak over the connected phone. Generally when a user open the phone, the outgoing call subsystem is initiated, however if a call is already connected 82 via the incoming call subsystem prior to the user opening the phone 84, the outgoing call subsystem is bypassed 85 and instead of calling the pre-programmed number, the user is simply connected 82 to the incoming call. In one embodiment of the present invention, there is no restriction on who can call the present invention. This is unlike the outgoing call system, where the present invention is designed to call only a single pre-programmed phone number. In another embodiment, the present invention has a restricted call list and can only receive phone calls from phone numbers on said list. In this embodiment, when a call from a phone number that is not on the call list is received, the incoming call system instead does not initiate a call alert and simply disconnects the incoming call from the non-approved phone number.

Referring now to FIG. 2C, there is shown a diagram of the input system of the present invention. The present input system allows individuals, who are generally not the user of the present device because the present invention is designed primarily for use by individuals who lack the technological acumen to make a phone call using a smartphone, to program and reprogram the outgoing call phone number stored in the present invention's storage medium, along with a plurality of other variables. This system is initiated when the present invention is connected 101 to another electronic device, which initiates 102 a user prompt on said electronic device. The other electronic device to which the present invention is connected may include a laptop or other such device. Furthermore, the connection may be a direct connection, such as via a USB connection, or may be a wireless connection. No claim is made as to the specific method used to connect the present invention and the electronic device to be used to program the present invention. A secondary electronic device is necessary to program the present invention because the present invention completely lacks any means for conveying input to the various subsystems, except a power button and a volume button. If the present invention were to have a keyboard, even if said keyboard was extremely paired down or simplified, it would defeat the main purpose of the present invention because such a keyboard or other input means would serve to confuse the user and make completing a phone call more difficult. Furthermore, no specific claim is made as to the form that the user prompt takes or the method by which it is initiated on the connected electronic device. It is submitted that methods of initiating prompts on connected electronic devices are known in the prior art.

Once the user prompt is initiated 102, the individual may then input 103 the phone number to be stored on the phone. Thereafter, said input is transferred 104 to the present invention through the connection to the electronic device and the input is then stored 105 in the present invention's storage medium. In alternative embodiments of the present invention, the user prompt may be used to program a variety of other variables of the systems of the present invention, including a list of restricted phone numbers from which the present invention may receive calls, the type of call alert initiated when a phone call is received by the present invention, and so forth. In further alternative embodiments of the present invention wherein the screen is adapted to display a picture or image associated with the incoming or outgoing phone number, the user prompt is adapted to be used to upload the picture or image onto the present phone and associate that picture or image with a phone number so that it is displayed whenever the phone calls or receives a call from that phone number.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mobile phone, comprising:
a housing having a speaker and a microphone;
a wireless transceiver adapted to send and receive signals over a wireless cellular network;
a storage medium adapted to store a single phone number;
wherein said mobile phone is adapted to call only said phone number;
wherein said mobile phone automatically calls said phone number when said mobile phone is opened, without any additional actuation by a user;
wherein said housing lacks any input means, except for a power button and a volume button.

2) The mobile phone of claim 1, wherein said mobile phone is a flip phone.

3) The mobile phone of claim 1, further comprising:
a means for connecting said mobile phone to a secondary electronic device;
wherein a user prompt is initiated on said secondary electronic device when said mobile phone is connected to said secondary electronic device;
wherein said user prompt may be utilized by a user to input said phone number and transfer said phone number to said storage medium to be stored therein.

4) The mobile phone of claim 3, wherein said user prompt is adapted to create and transfer a list of restricted phone numbers from which said mobile phone may only receive calls.

5) The mobile phone of claim 1, wherein said mobile phone is adapted to emit an alert when said mobile phone receives a phone call.

6) The mobile phone of claim 1, wherein said mobile phone comprises a means for detecting the position of a hinge of said mobile phone, and wherein said mobile phone automatically calls said phone number when said hinge is in an open configuration.

7) The mobile phone of claim 1, wherein said mobile phone comprises a screen on said housing, and wherein said screen displays a phone number corresponding to the call received or dialed.
